(19) United States
(12) Patent Application Publication
(10) Pub. No.: US 2026/0270695 A1
(43) Pub. Date: Sep. 10, 2026

(54) INFORMATION PROCESSING APPARATUS, COMMUNICATION APPARATUS, AND PROCESSING METHOD

(71) Applicant: SEIKO EPSON CORPORATION, Tokyo (JP)

(72) Inventor: Kazuki NAKAMURA, Shiojiri (JP)

(21) Appl. No.: 19/560,468

(22) Filed: Mar. 9, 2026

(30) Foreign Application Priority Data
Mar. 10, 2025 (JP) 2025-037064

(51) Int. Cl. H04W 12/0431; H04W 12/06; H04W 48/08

(52) U.S. Cl. CPC H04W 12/0431; H04W 12/06; H04W 48/08

(57) ABSTRACT

An information processing apparatus according to the present disclosure includes a bootstrapping unit configured to acquire bootstrapping information including a public key common to a plurality of communication apparatuses, and an authentication unit configured to, when a DPP Presence Announcement broadcast from any one of the plurality of communication apparatuses satisfies a predetermined condition, based on the acquired bootstrapping information, execute processing of an authentication phase defined in DPP on the communication apparatus having broadcast the DPP Presence Announcement.

The present application is based on, and claims priority from JP Application Serial Number 2025-037064, filed Mar. 10, 2025, the disclosure of which is hereby incorporated by reference herein in its entirety.

### BACKGROUND

### 1. Technical Field

The present disclosure relates to an information processing apparatus, a communication apparatus, and a processing method.

### 2. Related Art

A feature called Wi-Fi Easy Connect® developed by Wi-Fi Alliance is known. This feature is a technique in which a device called a Configurator provides access point information to a device called an Enrollee in accordance with Device Provisioning Protocol (DPP). This enables the Enrollee that has acquired the access point information to establish a wireless connection with the access point.

In this regard, JP-A-2019-205021 discloses the use of the DPP for wirelessly connecting a printing device to an access point.

In the DPP, in order for the Configurator to provide access point information to the Enrollee, the Configurator needs to acquire bootstrapping information of the Enrollee. The bootstrapping information is needed in an authentication phase where authentication processing is performed between the Configurator and the Enrollee. As methods for the Configurator to acquire the bootstrapping information of the Enrollee, various techniques are defined. For example, the DPP proposes a method of acquiring the information by using any one of QR code®, Near Field Communication (NFC), Bluetooth® Low Energy (BLE), and Public Key Exchange (PKEX) techniques. In addition, the DPP proposes acquisition by "Push Button PKEX-based method" using a button operation, acquisition from Trusted Third Party, and other methods.

When there are a plurality of communication apparatuses, that is, the Enrollees, to be wirelessly connected to the access point, the Configurator acquires bootstrapping information of each of the plurality of communication apparatuses in the existing technology. Accordingly, as the number of communication apparatuses to be wirelessly connected to the access point increases, the number of times the process for acquiring the bootstrapping information is executed also increases, and thus the processing load of the apparatus operating as the Configurator increases. In a case where a user operation is needed to acquire the bootstrapping information, as the number of communication apparatuses to be wirelessly connected to the access point increases, the time and effort required from the user also increases. Against this background, it is desired to reduce the processing load of the Configurator when there are a plurality of communication apparatuses to be wirelessly connected to the access point.

### SUMMARY

According to a first aspect of the present disclosure, an information processing apparatus includes a bootstrapping unit configured to acquire bootstrapping information defined in Device Provisioning Protocol (DPP), the bootstrapping information including a public key common to a plurality of communication apparatuses; and an authentication unit configured to, when a DPP Presence Announcement broadcast from any one of the plurality of communication apparatuses satisfies a predetermined condition, based on the acquired bootstrapping information, execute processing of an authentication phase defined in the DPP on the communication apparatus having broadcast the DPP Presence Announcement.

According to a second aspect of the present disclosure, a communication apparatus includes a bootstrapping unit configured to broadcast, as a DPP Presence Announcement defined in Device Provisioning Protocol (DPP), a signal including a value obtained from a predetermined public key common to a plurality of communication apparatuses; and an authentication unit configured to execute processing of an authentication phase defined in DPP by using the predetermined public key.

According to a third aspect of the present disclosure, a processing method includes acquiring bootstrapping information defined in Device Provisioning Protocol (DPP), the bootstrapping information including a public key common to a plurality of communication apparatuses; and when a DPP Presence Announcement broadcast from any one of the plurality of communication apparatuses satisfies a predetermined condition, based on the acquired bootstrapping information, executing processing of an authentication phase defined in DPP on the communication apparatus having broadcast the DPP Presence Announcement.

### BRIEF DESCRIPTION OF THE DRAWINGS

FIG. 1 is a schematic view illustrating an exemplary configuration of a system including communication apparatuses, an information processing apparatus, and an access point.

FIG. 2 is a block diagram illustrating an exemplary configuration of one of the communication apparatuses.

FIG. 3 is a block diagram illustrating an exemplary configuration of the information processing apparatus.

FIG. 4 is a schematic view illustrating an exemplary UI screen displayed on a UI unit.

FIG. 5A is a sequence diagram illustrating a wireless setting flow.

FIG. 5B is a sequence diagram illustrating the wireless setting flow.

FIG. 6 is a block diagram illustrating an exemplary configuration of a communication apparatus according to a first modification.

FIG. 7 is a schematic view illustrating an exemplary UI screen displayed on the UI unit.

FIG. 8 is a block diagram illustrating an exemplary hardware configuration of a computer included in the communication apparatus, the information processing apparatus, or the access point.

### DESCRIPTION OF EMBODIMENTS

Embodiments will now be described with reference to the figures. For clarity, certain description and figures may be omitted or simplified as appropriate. In each figure, identical elements are denoted by the same reference numerals, and redundant description is omitted where appropriate. In addition, not all features or steps illustrated in any one of the figures for describing the exemplary embodiments are necessarily indispensable, and some features or steps may be omitted. Furthermore, the order of the steps described in the figures may be changed as appropriate.

### First Embodiment

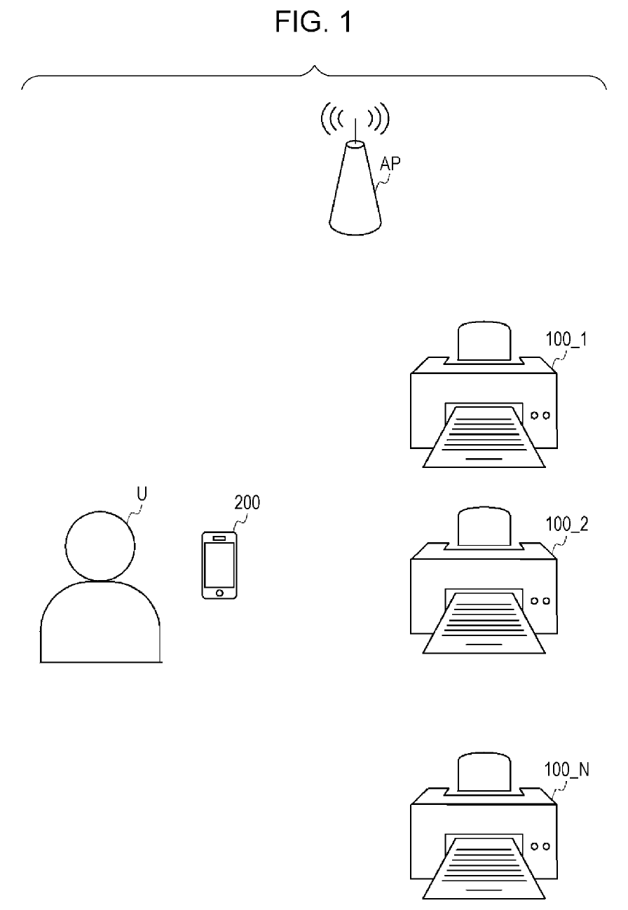

FIG. 1 is a schematic view illustrating an exemplary configuration of a system including communication apparatuses, an information processing apparatus, and an access point according to an embodiment. In FIG. 1, communication apparatuses 100_1 to 100_N are illustrated as communication apparatuses to be wirelessly connected to an access point AP. Here, N is an integer greater than or equal to 2. Hereinafter, the communication apparatuses 100_1 to 100_N are collectively referred to as the communication apparatuses 100 when no distinction is made between them. Specifically, the access point AP is, for example, a wireless Local Area Network (LAN) router.

In the present embodiment, each of the communication apparatuses 100, the information processing apparatus 200, and the access point AP includes Wi-Fi Easy Connect functionality. In the present embodiment, the information processing apparatus 200 operates as a Configurator defined in the DPP, and each of the plurality of communication apparatuses 100 operates as an Enrollee defined in the DPP. Each of the communication apparatuses 100 acquires access point information from the information processing apparatus 200 and establishes a wireless communication connection with the access point AP by using the acquired access point information.

Here, the access point information is information needed to establish a wireless communication connection with the access point AP. The access point information is referred to as a Configuration Object in the DPP and is transmitted from the Configurator to the Enrollee. The access point information may include, for example, at least one of a service set identifier (SSID) and a password of the access point AP. However, the access point information may include any information needed to establish a wireless communication connection with the access point AP, and may further include other information in addition to the SSID or the password, or together with the SSID or the password.

In the present embodiment, access point information is transmitted from the information processing apparatus 200 to the communication apparatus 100 in accordance with a procedure defined in the DPP. In the present embodiment, the information processing apparatus 200 already has the access point information at the timing when the process defined in the DPP is started between the information processing apparatus 200 and the communication apparatus 100. At this timing, for example, the information processing apparatus 200 has already established a wireless communication connection with the access point AP. On the other hand, at this timing, the communication apparatus 100 does not yet have access point information and has not established a wireless communication connection with the access point AP. The communication apparatus 100 is capable of establishing a wireless communication connection with the access point AP by acquiring the access point information from the information processing apparatus 200 in accordance with a procedure defined in the DPP.

In the present embodiment, the communication apparatus 100 is a printer that prints information on media such as paper. However, the communication apparatus 100 may be any apparatus having a communication function and is not necessarily limited to a printer.

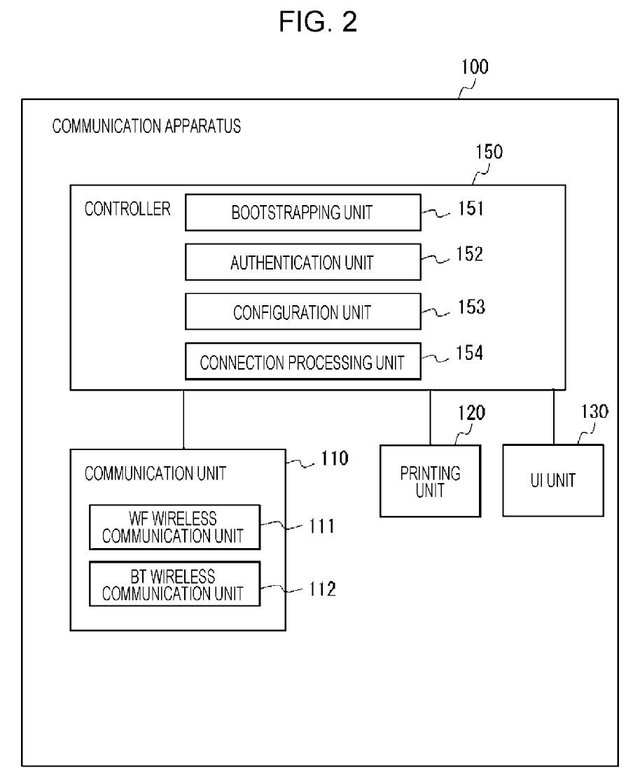

FIG. 2 is a block diagram illustrating an exemplary configuration of the communication apparatus 100. As illustrated in FIG. 2, the communication apparatus 100 includes a communication unit 110, a printing unit 120, a user interface (UI) unit 130, and a controller 150.

The communication unit 110 is a hardware circuit that wirelessly communicates with another device in conformity with a predetermined communication standard and may include software such as firmware. The communication unit 110 includes a WF wireless communication unit 111 and a BT wireless communication unit 112.

The WF wireless communication unit 111 is a circuit that communicates in accordance with a first wireless communication standard. That is, the WF wireless communication unit 111 transmits or receives information in accordance with the first wireless communication standard. In the present embodiment, the WF wireless communication unit 111 wirelessly communicates in accordance with the Wi-Fi® standard.

The BT wireless communication unit 112 is a circuit that communicates in accordance with a second wireless communication standard. That is, the BT wireless communication unit 112 transmits or receives information in accordance with the second wireless communication standard. In the present embodiment, the BT wireless communication unit 112 performs Bluetooth® communication, which is communication in accordance with the Bluetooth standard. More specifically, in the present embodiment, the BT wireless communication unit 112 wirelessly communicates in accordance with the BLE standard, which is a Bluetooth low power consumption standard. When Bluetooth communication is unnecessary, the communication apparatus 100 does not necessarily include the BT wireless communication unit 112.

The printing unit 120 includes a printing engine, which is a mechanical configuration that performs printing on media. In the present embodiment, the printing unit 120 will be described as having an ink jet printing configuration. However, the printing unit 120 may include a printing engine configured to perform printing using a coloring material, such as toner, by an electrophotographic printing method. In addition, the media is, for example, paper, but may be cloth or another material.

In the present embodiment, the printing unit 120 includes, as a printing engine, for example, a print head that ejects a coloring material onto media. The print head performs ink jet printing using a supplied coloring material, specifically ink. The printing engine may further include, in addition to the print head, a media container that holds media, a transport mechanism that transports the media from the media container to a position facing the print head, a drive mechanism that drives a carriage including the print head, and other components. In this case, the printing unit 120 prints information such as an image on the media by ejecting the coloring material from the print head onto the media transported by the transport mechanism.

The UI unit 130 is a component that functions as a user interface. In the present embodiment, the UI unit 130 includes a display. The UI unit 130 may further include an input device such as a button or a pointing device that receives an input operation from a user. The UI unit 130 may be implemented as a touch panel in which an input device and a display are integrally configured.

The controller 150 controls the operation of the communication apparatus 100. In particular, as illustrated in FIG. 2, the controller 150 includes a bootstrapping unit 151, an authentication unit 152, a configuration unit 153, and a connection processing unit 154, which function to establish a wireless communication connection between the access point AP and the WF wireless communication unit 111.

The bootstrapping unit 151, the authentication unit 152, the configuration unit 153, and the connection processing unit 154 execute processing for configuring wireless settings in the communication apparatus 100. That is, these units execute processing for establishing a wireless communication connection between the access point AP and the WF wireless communication unit 111. In particular, in the present embodiment, as described above, a wireless communication connection between the access point AP and the WF wireless communication unit 111 is established in accordance with a procedure defined in the DPP, that is, Wi-Fi Easy Connect.

In the DPP, processing in which a device operating as an Enrollee acquires a Configuration Object, such as access point information, from a device operating as a Configurator consists of three phases. Specifically, in the DPP, the processing of acquiring the Configuration Object, which is access point information, consists of three phases: bootstrapping, authentication, and configuration.

Bootstrapping is a phase in which the Configurator acquires bootstrapping information of the Enrollee. The bootstrapping information is information necessary for authentication, which is the next phase after bootstrapping, and includes a bootstrapping key defined in the DPP. The bootstrapping key is a public key of the Enrollee. The bootstrapping information may also be referred to as information necessary for the Configurator to start communication with the Enrollee, which is communication in the authentication phase described later. The bootstrapping information includes individual identification information of the Enrollee in addition to the bootstrapping key, which is the public key. The individual identification information may be a media access control (MAC) address or a serial number of a device that operates as the Enrollee. In the bootstrapping phase, the Enrollee transmits a signal called a DPP Presence Announcement as defined in the DPP. This signal is transmitted via Wi-Fi communication. The DPP Presence Announcement is a signal broadcast by the Enrollee together with the individual identification information of the Enrollee in the bootstrapping phase. The DPP Presence Announcement is a signal for notifying the Configurator that the process in accordance with the DPP is executable and includes the hash value of the bootstrapping key, which is the public key, of the Enrollee.

In the present embodiment, for example, the Configurator acquires bootstrapping information by reading a two-dimensional code image, such as a QR code, in which the bootstrapping information of the Enrollee is encoded. However, this method is merely exemplary, and the Configurator according to the present embodiment may acquire bootstrapping information by another publicly known method.

Communication between the Configurator and the Enrollee in the authentication phase and the configuration phase is performed in accordance with the Wi-Fi standard.

Authentication is a phase in which the Configurator and the Enrollee authenticate each other and generate a shared key used for encryption during transmission of the Configuration Object. That is, in this phase, a key for encrypting the Configuration Object, which is access point information, is generated. Each of the Configurator and the Enrollee generates a shared key based on, for example, Elliptic Curve Diffie-Hellman key exchange (ECDH). In the authentication phase, first, the Configurator transmits a signal called a DPP Authentication Request to the Enrollee. This signal includes a message generated using the bootstrapping information of the Enrollee. Accordingly, the bootstrapping information can be described as information that needs to be provided to the Configurator in order for the Configurator to start communication in accordance with a predetermined communication process, namely a DPP Authentication Request, with the Enrollee. In the authentication phase, after the DPP Authentication Request is transmitted, a signal called a DPP Authentication Response is transmitted from the Enrollee to the Configurator. Finally, a signal referred to as a DPP Authentication Confirm is transmitted from the Configurator to the Enrollee.

Configuration is a phase in which the Configuration Object, such as access point information, is transmitted from the Configurator to the Enrollee via encrypted communication using the shared key generated in the authentication phase. Specifically, in the configuration phase, first, the Enrollee transmits a signal referred to as a DPP Configuration Request to the Configurator. In response to this, the Configurator transmits a signal referred to as a DPP Configuration Response to the Enrollee. The DPP Configuration Response includes the Configuration Object, which is access point information. In the configuration phase, information called Connector, which is signed by the Configurator, is also transmitted from the Configurator to the Enrollee.

The bootstrapping unit 151 executes processing of the Enrollee in the bootstrapping phase. The authentication unit 152 executes processing of the Enrollee in the authentication phase. The configuration unit 153 executes processing of the Enrollee in the configuration phase.

In the present embodiment, a plurality of communication apparatuses 100 execute processing defined in the DPP by using a common bootstrapping key, which is a common public key. Therefore, the information processing apparatus 200 operating as the Configurator does not need to acquire a bootstrapping key from each of the plurality of communication apparatuses 100. Accordingly, the information processing apparatus 200 only needs to acquire one piece of bootstrapping information and does not need to repeatedly acquire bootstrapping information. When the Configurator, which is the information processing apparatus 200, does not acquire bootstrapping information of each Enrollee, which is each communication apparatus 100, the Configurator cannot acquire the individual identification information included in the bootstrapping information. In the authentication phase, a DPP Authentication Request to an Enrollee is transmitted via unicast by the Configurator. Therefore, when the Configurator does not acquire bootstrapping information of each Enrollee, the Configurator may be unable to identify the destination of the DPP Authentication Request. However, the bootstrapping unit 151 of the communication apparatus 100 transmits a DPP Presence Announcement defined in the DPP, thereby enabling the Configurator to identify the destination of the DPP Authentication Request. This is because the broadcast DPP Presence Announcement frame includes individual identification information of the Enrollee serving as a transmission source. As described above, in the present embodiment, each communication apparatus 100 uses, as a bootstrapping key, a predetermined public key common to a plurality of communication apparatuses 100. Accordingly, in the present embodiment, the bootstrapping unit 151 of the communication apparatus 100 broadcasts, as a DPP Presence Announcement defined in the DPP, a signal including a value obtained from the predetermined public key common to the plurality of communication apparatuses 100, specifically a hash value of the public key. The predetermined public key common to the plurality of communication apparatuses 100 will be simply referred to as a common public key hereinafter. When providing bootstrapping information to the information processing apparatus 200, the bootstrapping unit 151 of the communication apparatus 100 provides bootstrapping information including the common public key to the information processing apparatus 200. When the bootstrapping unit 151 provides bootstrapping information to the information processing apparatus 200 by outputting the two-dimensional code image, such as a QR code, the bootstrapping unit 151 generates an image of the two-dimensional code in which the bootstrapping information is encoded and causes the UI unit 130 to display the image. The bootstrapping unit 151 may alternatively cause the printing unit 120 to print the image. As described above, the method of providing bootstrapping information is not limited to output of a two-dimensional code image. Accordingly, the bootstrapping unit 151 may provide the bootstrapping information by another publicly known providing method.

In the present embodiment, the authentication unit 152 of the communication apparatus 100 executes processing of the authentication phase defined in the DPP by using the common public key. After this processing is performed by the authentication unit 152, the configuration unit 153 performs processing of the configuration phase to acquire access point information of the access point AP from the information processing apparatus 200. After the access point information is acquired, the connection processing unit 154 performs processing for establishing a wireless communication connection with the access point AP using the acquired access point information. More specifically, the connection processing unit 154 performs processing for establishing a wireless communication connection with the access point AP using the access point information and the Connector. Specifically, the connection processing unit 154 establishes a wireless communication connection with the access point AP by executing processing of the network introduction phase defined in the DPP.

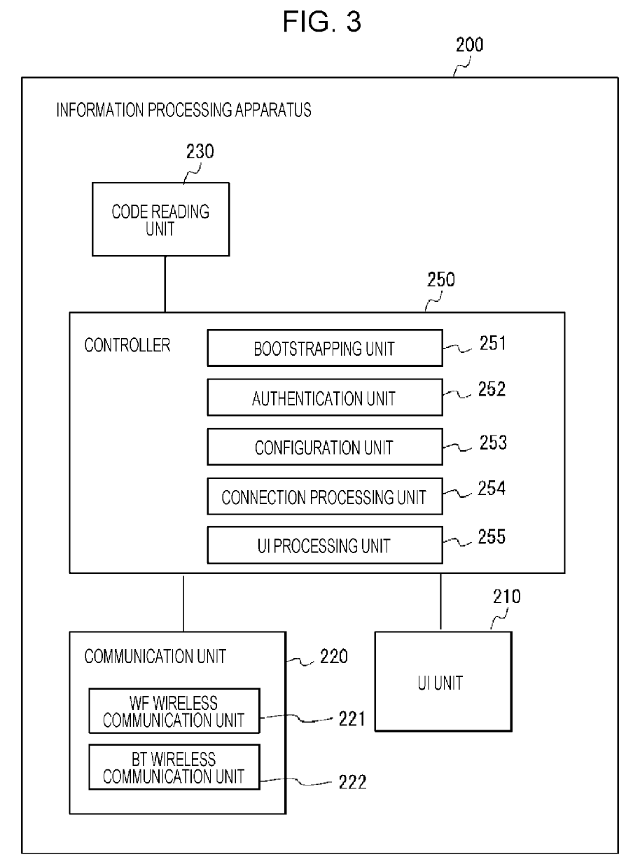

The information processing apparatus 200 will now be described. The information processing apparatus 200 is an apparatus operated by a user U, and is, for example, a smartphone, a tablet terminal, or a personal computer. FIG. 3 is a block diagram illustrating an exemplary configuration of the information processing apparatus 200. As illustrated in FIG. 3, the information processing apparatus 200 includes a UI unit 210, a communication unit 220, a code reading unit 230, and a controller 250.

The UI unit 210 is a user interface device including a display and an input device, such as a button or a pointing device, that receives an input operation from the user U. The UI unit 210 may be a touch panel in which the input device and the display are integrally configured.

The communication unit 220 is a hardware circuit that performs wireless communication with another device in conformity with a predetermined communication standard, and may include software such as firmware. The communication unit 220 includes a WF wireless communication unit 221 and a BT wireless communication unit 222.

The WF wireless communication unit 221 is a circuit that communicates in accordance with the first wireless communication standard described above. Specifically, the WF wireless communication unit 221 wirelessly communicates in accordance with the Wi-Fi standard.

The BT wireless communication unit 222 is a circuit that communicates in accordance with the second wireless communication standard described above. In the present embodiment, the BT wireless communication unit 222 performs Bluetooth® communication, which is communication in accordance with the Bluetooth standard. More specifically, in the present embodiment, the BT wireless communication unit 222 wirelessly communicates in accordance with the BLE standard. When Bluetooth communication is unnecessary, the information processing apparatus 200 does not necessarily include the BT wireless communication unit 222.

The code reading unit 230 is a reader that reads a code image such as a QR code. The code reading unit 230 may include a scanner or a camera as hardware for reading. The code reading unit 230 decodes a scanned or captured code image and reads information represented by the code image. Accordingly, the code reading unit 230 is capable of reading a code image that represents bootstrapping information.

The controller 250 controls the operation of the information processing apparatus 200. In particular, as illustrated in FIG. 3, the controller 250 includes, as functions for configuring wireless settings, a bootstrapping unit 251, an authentication unit 252, a configuration unit 253, a connection processing unit 254, and a UI processing unit 255. The bootstrapping unit 251, the authentication unit 252, the configuration unit 253, the connection processing unit 254, and the UI processing unit 255 may be implemented as functions included in a setting application (application software) installed on the information processing apparatus 200.

The bootstrapping unit 251 executes processing of the Configurator in the bootstrapping phase. The authentication unit 252 executes processing of the Configurator in the authentication phase. The configuration unit 253 executes processing of the Configurator in the configuration phase. The bootstrapping unit 251, the authentication unit 252, and the configuration unit 253 mainly execute processing defined in the DPP for the communication apparatus 100 operating as an Enrollee, but may execute processing defined in the DPP for the access point AP operating as an Enrollee. The connection processing unit 254 executes processing for establishing a wireless communication connection with the access point AP operating as an Enrollee. Specifically, the connection processing unit 254 establishes a wireless communication connection between the information processing apparatus 200 and the access point AP by executing processing of the network introduction phase defined in the DPP.

In the present embodiment, in order to transmit access point information to each of the plurality of communication apparatuses 100, the bootstrapping unit 251 acquires bootstrapping information defined in the DPP that includes a public key common to the plurality of communication apparatuses 100. That is, the bootstrapping unit 251 acquires bootstrapping information including the common public key described above, specifically the common bootstrapping key. For example, the bootstrapping unit 251 acquires the bootstrapping information from any one of the plurality of communication apparatuses 100. More specifically, the bootstrapping unit 251, for example, acquires the bootstrapping information provided by the communication apparatus 100 for which wireless settings are configured first among the plurality of communication apparatuses 100. For example, the bootstrapping unit 251 acquires the bootstrapping information including the common public key by the code reading unit 230 reading a two-dimensional code image, such as a QR code, output from the communication apparatus 100 for which wireless settings are to be configured first. However, the bootstrapping unit 251 may acquire the bootstrapping information by another publicly known providing method.

In addition, in the present embodiment, when a DPP Presence Announcement broadcast from any one of the plurality of communication apparatuses 100 satisfies a predetermined condition, the authentication unit 252 executes the following processing. Specifically, in this case, the authentication unit 252 executes processing of the authentication phase on the communication apparatus 100 that has broadcast the DPP Presence Announcement, based on the acquired bootstrapping information of the communication apparatus 100. The predetermined condition described above is a condition that a value obtained from the received DPP Presence Announcement matches a value obtained from the acquired bootstrapping information of the communication apparatus 100. The value obtained from the received DPP Presence Announcement is specifically a hash value of the public key included in the DPP Presence Announcement. The value obtained from the acquired bootstrapping information of the communication apparatus 100 may also be described as a value obtained from the public key included in the bootstrapping information. Specifically, the value obtained from the public key included in the bootstrapping information is a hash value calculated by applying a predetermined hash function, which is a hash function used by the communication apparatus 100 to calculate the hash value of the public key, to the public key. The authentication unit 252 calculates a hash value of the public key included in the bootstrapping information by using the hash function, and compares the calculated hash value with the hash value included in the DPP Presence Announcement. Thus, it is determined whether the predetermined condition is satisfied. In this manner, by determining whether the predetermined condition is satisfied, processing of the authentication phase can be executed on the communication apparatus 100 that is waiting for configuration of wireless settings using the common public key.

After processing by the authentication unit 252, processing by the configuration unit 253 is performed. The configuration unit 253 transmits access point information of the access point AP held by the information processing apparatus 200 to the communication apparatus 100 in accordance with a process defined in the DPP.

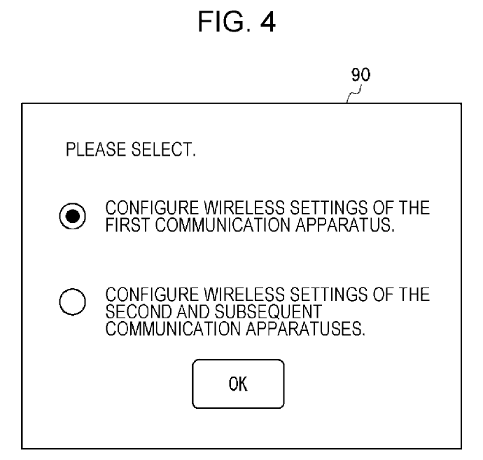

The UI processing unit 255 receives, from the user U, an input for specifying whether the communication apparatus targeted for wireless settings is the communication apparatus for which wireless settings are to be configured first among the plurality of communication apparatuses 100. That is, the UI processing unit 255 receives, from the user U, an input for specifying whether wireless settings are to be configured for a first communication apparatus 100 or a second or subsequent communication apparatus 100, among the plurality of communication apparatuses 100. The UI processing unit 255 may cause a UI screen for receiving the input to be displayed on the UI unit 210. FIG. 4 is a schematic view illustrating an exemplary UI screen 90 displayed on the UI unit 210 by the UI processing unit 255.

When the UI processing unit 255 receives an input specifying that the communication apparatus targeted for wireless settings is the communication apparatus for which wireless settings are to be configured first among the plurality of communication apparatuses 100, the UI processing unit 255 notifies the user U of acquisition of bootstrapping information of the communication apparatus 100 targeted for wireless settings. That is, when the communication apparatus targeted for wireless settings is the communication apparatus for which wireless settings are to be configured first among the plurality of communication apparatuses 100, the UI processing unit 255 notifies the user U of acquisition of the bootstrapping information of the communication apparatus 100. Specifically, for example, the UI processing unit 255 causes such a notification to be displayed on the UI unit 210. For example, the UI processing unit 255 causes a message such as "Please read the QR code output by the communication apparatus by using the information processing apparatus" to be displayed on the UI unit 210. When the communication apparatus targeted for wireless settings is the communication apparatus for which wireless settings are to be configured first, the UI processing unit 255 may activate the code reading unit 230, such as a camera. In addition, when bootstrapping information of the communication apparatus 100 is provided using a Public Key Exchange (PKEX) protocol, a passkey has to be input in the Configurator, which is the information processing apparatus 200, in some cases. Therefore, the UI processing unit 255 may cause a passkey input screen to be displayed on the UI unit 210 when the communication apparatus targeted for wireless settings is the communication apparatus for which wireless settings are to be configured first.

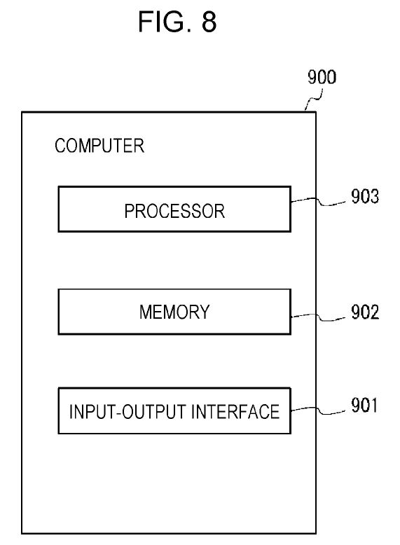

When the communication apparatus targeted for wireless settings is the communication apparatus for which wireless settings are to be configured first among the plurality of communication apparatuses 100, the bootstrapping unit 251 acquires bootstrapping information including the common public key and stores the bootstrapping information in a storage device of the information processing apparatus 200 or the like. The storage device may be a memory 902 described later with reference to FIG. 8, or may be different from the memory 902. The bootstrapping information, which includes the common public key, acquired at this time can also be used for the wireless settings of second and subsequent apparatuses, and therefore the information processing apparatus 200 does not need to acquire additional bootstrapping information.

When the communication apparatus targeted for wireless settings is the communication apparatus for which wireless settings are to be configured first among the plurality of communication apparatuses 100, the authentication unit 252 operates as follows. In this case, when bootstrapping information of the communication apparatus 100 for which wireless settings are to be configured first is acquired, the authentication unit 252 executes processing of the authentication phase on the communication apparatus 100 based on the acquired bootstrapping information of the communication apparatus 100. That is, the authentication unit 252 transmits a DPP Authentication Request using the acquired bootstrapping information, which is the common public key. At this time, the authentication unit 252 determines a transmission destination of the DPP Authentication Request based on the individual identification information included in the acquired bootstrapping information.

In contrast, when the communication apparatus targeted for wireless settings is not the communication apparatus for which wireless settings are to be configured first among the plurality of communication apparatuses 100, the authentication unit 252 operates as follows. In this case, a DPP Presence Announcement broadcast from any one of the plurality of communication apparatuses 100, specifically, the communication apparatus 100 targeted for wireless settings, is searched for. Then, the authentication unit 252 verifies whether the discovered DPP Presence Announcement, that is, the received DPP Presence Announcement satisfies the predetermined condition described above. Specifically, the authentication unit 252 verifies whether a hash value calculated from the public key included in the bootstrapping information acquired during the first wireless settings matches a hash value included in the received DPP Presence Announcement. When the hash values match, the authentication unit 252 transmits a DPP Authentication Request using the common public key acquired during the first wireless settings. At this time, the authentication unit 252 determines a transmission destination of the DPP Authentication Request by using the individual identification information indicating a transmission source of the DPP Presence Announcement. When the UI processing unit 255 receives an input specifying that the communication apparatus targeted for wireless settings is not the communication apparatus for which wireless settings are to be configured first among the plurality of communication apparatuses 100, the UI processing unit 255 may cause the screen illustrated in FIG. 4 to transition to a screen indicating waiting for reception of a DPP Presence Announcement.

In this manner, the information processing apparatus 200 executes processing depending on whether the communication apparatus targeted for wireless settings is the communication apparatus for which wireless settings are to be configured first among the plurality of communication apparatuses 100. This enables appropriate wireless settings to be achieved in both a case where wireless settings of a first apparatus are configured and a case where wireless settings of a second or subsequent apparatus are configured.

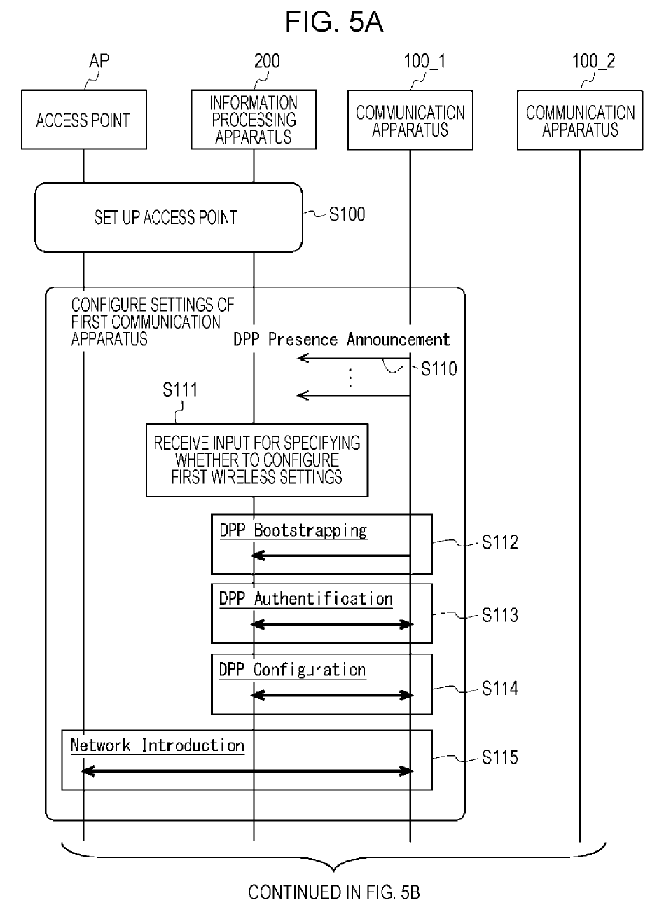

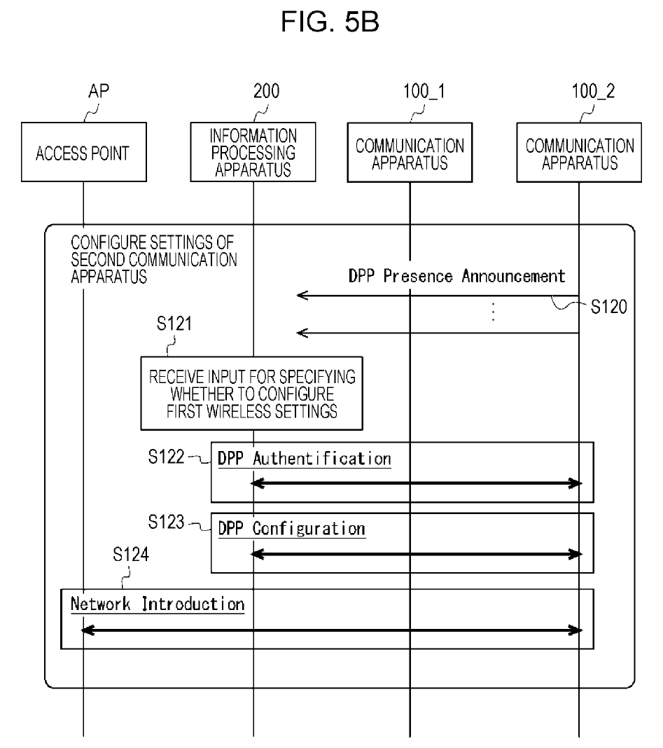

FIGS. 5A and 5B are sequence diagrams illustrating a wireless setting flow in the present embodiment. Hereinafter, the wireless setting flow in the present embodiment will be described with reference to the sequence diagrams illustrated in the drawings.

First, in step S100, the access point AP is set up. In step S100, processing is performed in accordance with a process defined in the DPP between the information processing apparatus 200 and the access point AP. At this time, the access point AP operates as an Enrollee, and the information processing apparatus 200 operates as a Configurator. In step S100, the information processing apparatus 200 performs processing in the bootstrapping phase, the authentication phase, the configuration phase, and the network introduction phase on the access point AP. As a result, the information processing apparatus 200 establishes a wireless communication connection with the access point AP. In the bootstrapping phase in step S100, it is necessary for the information processing apparatus 200 to acquire the bootstrapping information of the access point AP. The bootstrapping information of the access point AP includes a public key unique to the access point AP, which is different from the common public key described above. In step S100, a Connector signed by the Configurator, which is the information processing apparatus 200, is transmitted from the information processing apparatus 200 to the access point AP. In addition, in step S100, the access point information may be transmitted from the information processing apparatus 200 to the access point AP.

After step S100, wireless settings are sequentially configured for the plurality of communication apparatuses 100. FIGS. 5A and 5B are sequence diagrams illustrating a case where wireless settings for the communication apparatus 100_1 are configured first and then wireless settings for the communication apparatus 100_2 are configured. Configuration of wireless settings for a third or subsequent communication apparatus 100 is the same as that for the second communication apparatus 100_2. Therefore, the sequence diagrams illustrated in FIGS. 5A and 5B illustrate the process flow up to the configuration of wireless settings for the second communication apparatus 100.

As processing for the communication apparatus 100_1 for which wireless settings are configured first, steps S110 to S115 are performed.

In step S110, the bootstrapping unit 151 of the communication apparatus 100_1 starts broadcasting a DPP Presence Announcement in response to the user U activating the communication apparatus 100_1 or in response to the user U performing an operation of instructing the UI unit 130 of the communication apparatus 100_1 to start wireless settings. As described above, in the present embodiment, a DPP Presence Announcement transmitted by the communication apparatus 100 includes a hash value of the common public key. However, since the communication apparatus 100_1 is the communication apparatus for which wireless settings are to be configured first, in the present embodiment, the signal transmitted in step S110 is not necessary for the information processing apparatus 200 to perform processing.

In step S111, the UI processing unit 255 of the information processing apparatus 200 receives, from the user U, an input for specifying whether the communication apparatus targeted for wireless settings is the communication apparatus for which wireless settings are to be configured first among the plurality of communication apparatuses 100. In this step, the UI processing unit 255 receives an input specifying that the communication apparatus targeted for wireless settings is the communication apparatus for which wireless settings are to be configured first. Accordingly, the UI processing unit 255 notifies the user U of acquisition of the bootstrapping information of the communication apparatus 100_1 targeted for wireless settings.

Next, in step S112, the bootstrapping unit 251 of the information processing apparatus 200 acquires bootstrapping information of the communication apparatus 100_1. That is, the bootstrapping unit 251 acquires bootstrapping information including the common public key. For example, the bootstrapping unit 251 acquires bootstrapping information including the common public key and individual identification information of the communication apparatus 100_1 by reading a two-dimensional code image, such as a QR code, output from the communication apparatus 100_1 by using the code reading unit 230. As described above, the bootstrapping unit 251 may acquire bootstrapping information provided by another known providing method.

After step S112, in step S113, the authentication unit 252 of the information processing apparatus 200 and the authentication unit 152 of the communication apparatus 100_1 execute processing of the authentication phase. Specifically, first, by using the common public key, the authentication unit 252 of the information processing apparatus 200 transmits a DPP Authentication Request to the communication apparatus 100_1 identified by the individual identification information included in the acquired bootstrapping information. In response to this, the communication apparatus 100_1 transmits a DPP Authentication Response to the information processing apparatus 200. Then, the information processing apparatus 200 transmits a DPP Authentication Confirm to the communication apparatus 100_1.

Next, in step S114, the configuration unit 253 of the information processing apparatus 200 and the configuration unit 153 of the communication apparatus 100_1 execute processing of the configuration phase. As a result, the communication apparatus 100_1 acquires access point information. Thereafter, in step S115, the connection processing unit 154 of the communication apparatus 100_1 establishes a wireless communication connection with the access point AP by executing processing of the network introduction phase using the acquired access point information.

Next, as processing for the second communication apparatus 100_2, steps S120 to S124 are performed.

In step S120, the bootstrapping unit 151 of the communication apparatus 100_2 starts broadcasting a DPP Presence Announcement in response to the user U activating the communication apparatus 100_2 or in response to the user U performing an operation of instructing the UI unit 130 of the communication apparatus 100_2 to start wireless settings. This DPP Presence Announcement also includes a hash value of the common public key.

In step S121, the UI processing unit 255 of the information processing apparatus 200 receives, from the user U, an input for specifying whether the communication apparatus targeted for wireless settings is the communication apparatus for which wireless settings are to be configured first among the plurality of communication apparatuses 100. In this step, the UI processing unit 255 receives an input specifying that the communication apparatus targeted for wireless settings is not the communication apparatus for which wireless settings are to be configured first. Thus, the authentication unit 252 starts searching for a DPP Presence Announcement. That is, the information processing apparatus 200 enters a state of waiting to receive a DPP Presence Announcement. Then, the DPP Presence Announcement broadcast in step S120 is received by the information processing apparatus 200.

In wireless settings of a second or subsequent communication apparatus 100, processing for acquiring bootstrapping information is omitted. Therefore, after step S121, in step S122, the authentication unit 252 of the information processing apparatus 200 and the authentication unit 152 of the communication apparatus 100_2 execute processing of the authentication phase. Specifically, first, the authentication unit 252 of the information processing apparatus 200 verifies whether the DPP Presence Announcement broadcast in step S120 satisfies the predetermined condition. That is, the authentication unit 252 verifies whether a hash value calculated from the public key included in the bootstrapping information acquired in step S112 matches a hash value included in the DPP Presence Announcement broadcast by the communication apparatus 100_2. When the hash values match, the authentication unit 252 transmits a DPP Authentication Request using the common public key included in the bootstrapping information acquired in step S112. Specifically, the authentication unit 252 determines a transmission destination of the DPP Authentication Request by using the individual identification information indicating a transmission source of the received DPP Presence Announcement. In response to this, the communication apparatus 100_2 transmits a DPP Authentication Response to the information processing apparatus 200. Then, the information processing apparatus 200 transmits a DPP Authentication Confirm to the communication apparatus 100_2. In this manner, in wireless settings of a second or subsequent communication apparatus, authentication is performed using the common public key included in the bootstrapping information acquired during wireless settings of the first communication apparatus 100, specifically the bootstrapping information acquired in step S112. In other words, in wireless settings of a second or subsequent communication apparatus, the information processing apparatus 200 omits processing of the bootstrapping phase and executes processing of the authentication phase.

Next, in step S123, the configuration unit 253 of the information processing apparatus 200 and the configuration unit 153 of the communication apparatus 100_2 execute processing of the configuration phase. As a result, the communication apparatus 100_2 acquires the access point information. Thereafter, in step S124, the connection processing unit 154 of the communication apparatus 100_2 establishes a wireless communication connection with the access point AP by executing processing of the network introduction phase using the acquired access point information.

In this manner, in the sequence diagrams described above, during wireless settings of the communication apparatus 100_2, the authentication unit 252 of the information processing apparatus 200 operates as follows. That is, the authentication unit 252 of the information processing apparatus 200 executes processing of the authentication phase on the communication apparatus 100_2 that has broadcast the DPP Presence Announcement, based on the bootstrapping information acquired from the communication apparatus 100_1.

The first embodiment has been described above. In the present embodiment, a public key common to a plurality of communication apparatuses 100 is used as the bootstrapping key. The bootstrapping unit 251 of the information processing apparatus 200 as a Configurator acquires the bootstrapping information including the common public key. In addition, when the broadcast DPP Presence Announcement satisfies a predetermined condition, the authentication unit 252 executes processing of the authentication phase on the communication apparatus 100 that has broadcast the DPP Presence Announcement, based on the bootstrapping information described above. Therefore, the information processing apparatus 200 only needs to acquire one piece of bootstrapping information and does not need to repeat acquisition of bootstrapping information in accordance with the number of communication apparatuses 100 for which wireless settings are to be configured. Accordingly, even when there are a plurality of communication apparatuses 100 to be wirelessly connected to the access point AP, the processing load on the information processing apparatus 200 operating as the Configurator may be suppressed. In addition, when a user operation is required during acquisition of bootstrapping information, such as a reading operation of a two-dimensional code image, such as a QR code, or an input operation of a passkey for PKEX, time and effort required from the user may be reduced according to the present embodiment. Furthermore, the communication apparatus 100 according to the present embodiment includes the bootstrapping unit 151 that broadcasts a DPP Presence Announcement including a hash value of a common public key and the authentication unit 152 that executes processing of the authentication phase by using the common public key. That is, the communication apparatus 100 according to the present embodiment has a configuration corresponding to the configuration of the information processing apparatus 200 described above. Therefore, the communication apparatus 100 having such a configuration contributes to suppression of a processing load on the information processing apparatus 200 operating as the Configurator and reduction of time and effort of the user during acquisition of bootstrapping information.

### Second Embodiment

Next, a second embodiment will be described regarding differences in configuration or processing from the first embodiment. In the embodiment described above, as illustrated in step S112, during wireless settings of the first communication apparatus 100, the information processing apparatus 200 needs to acquire bootstrapping information from an external source, such as the communication apparatus 100_1. In contrast, in the present embodiment, bootstrapping information including a common public key is stored in advance in the information processing apparatus 200. The bootstrapping information stored in advance in the information processing apparatus 200 may include only the common public key. For example, bootstrapping information including the common public key is stored in a storage device of the information processing apparatus 200 when a setting application including the bootstrapping unit 251, the authentication unit 252, the configuration unit 253, the connection processing unit 254, and the UI processing unit 255 is installed in the information processing apparatus 200. The storage device may be the memory 902 described later with reference to FIG. 8, or may be different from the memory 902.

In the present embodiment, the bootstrapping unit 251 of the information processing apparatus 200 acquires bootstrapping information, which is the common public key, stored in advance in the information processing apparatus 200. Then, the authentication unit 252 of the information processing apparatus 200 executes processing of the authentication phase on the communication apparatus 100 that has broadcast the DPP Presence Announcement, based on the bootstrapping information, which is the common public key, stored in advance in the information processing apparatus 200. In this manner, in the present embodiment, the information processing apparatus 200 acquires the bootstrapping information, which is the common public key, stored in advance in the information processing apparatus 200, instead of acquiring the bootstrapping information, which is the common public key, from the communication apparatus 100 that is a candidate for wireless settings.

In the first embodiment, as illustrated in FIGS. 5A and 5B, a flow of processing differs depending on whether the communication apparatus targeted for wireless settings is the communication apparatus for which wireless settings are to be configured first. However, in the present embodiment, the flow of processing is the same regardless of whether the communication apparatus targeted for wireless settings is the communication apparatus for which wireless settings are to be configured first. That is, in the present embodiment, the same processing as processing from step S120 to step S124 illustrated in FIG. 5B is performed for wireless settings of the first communication apparatus. However, in the present embodiment, bootstrapping information stored in advance in the information processing apparatus 200 is used instead of the bootstrapping information acquired in step S112.

According to the present embodiment, as described above, bootstrapping information, which is the common public key, stored in advance in the information processing apparatus 200 is used. Therefore, in the present embodiment, even when wireless settings are configured for the first communication apparatus 100, the information processing apparatus 200 does not need to acquire bootstrapping information from an external device. Therefore, according to the present embodiment, processing load for acquiring bootstrapping information from an external device is reduced. In addition, according to the present embodiment, time and effort of the user for acquiring the bootstrapping information may be reduced.

Although the first embodiment and the second embodiment have been described above, the following modifications of these embodiments are also proposed.

### First Modification Example

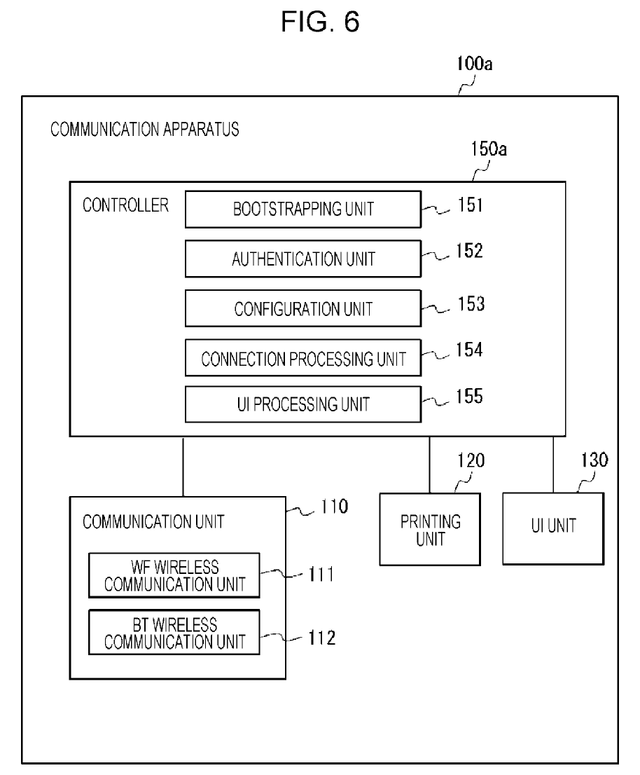

FIG. 6 is a block diagram illustrating an exemplary configuration of a communication apparatus 100a according to a first modification of the embodiments. The communication apparatus 100a differs from the communication apparatus 100 illustrated in FIG. 2 in that the controller 150 is replaced with a controller 150a. Hereinafter, description of configurations or processing that are the same as those of the embodiments will be appropriately omitted.

The controller 150a differs from the controller 150 in that the controller 150a further includes a UI processing unit 155. The UI processing unit 155 receives, from the user U, an input for specifying whether to enable a predetermined wireless setting mode for wireless settings on a plurality of communication apparatuses 100a. The predetermined wireless setting mode is a mode in which wireless settings are configured using a common public key, as described in the first or second embodiment. The UI processing unit 155 may cause a UI screen for receiving the input to be displayed on the UI unit 130.

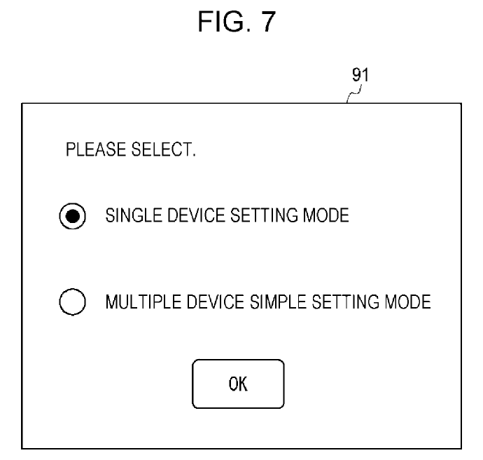

FIG. 7 is a schematic view illustrating an exemplary UI screen 91 displayed on the UI unit 130 by the UI processing unit 155. On the UI screen 91, the predetermined wireless setting mode described above is represented as "multiple device simple setting mode". In the example illustrated in FIG. 7, selection of "multiple device simple setting mode" on the UI screen 91 corresponds to an input specifying that the predetermined wireless setting mode described above be enabled. Accordingly, when the user U selects "multiple device simple setting mode" on the UI screen 91, the UI processing unit 155 receives an input specifying that the predetermined wireless setting mode described above be enabled. On the other hand, selection of "single device setting mode" on the UI screen 91 corresponds to an input specifying that the predetermined wireless setting mode described above is not to be enabled. Accordingly, when the user U selects "single device setting mode" on the UI screen 91, the UI processing unit 155 receives an input specifying that the predetermined wireless setting mode described above is not to be enabled. The "single device setting mode" is a mode in which wireless settings are configured without using a common public key. That is, the "single device setting mode" is a mode in which wireless settings are configured using a public key that is different for each communication apparatus 100a. For example, when configuring wireless settings of each communication apparatus 100a, the user U selects one of the modes for each communication apparatus 100a.

When the UI processing unit 155 receives an input specifying that the predetermined wireless setting mode be enabled, for example, when "multiple device simple setting mode" in FIG. 7 is selected, the bootstrapping unit 151 and the authentication unit 152 of the communication apparatus 100a operate as follows, as in the first and second embodiments. In this case, the bootstrapping unit 151 broadcasts, as a DPP Presence Announcement, a signal including a value obtained from a predetermined common public key common to the plurality of communication apparatuses 100a, specifically a hash value of the common public key. In addition, in this case, the authentication unit 152 executes processing of the authentication phase defined in the DPP by using the common public key.

On the other hand, when the UI processing unit 155 receives an input specifying that the predetermined wireless setting mode is not to be enabled, for example, when the "single device setting mode" in FIG. 7 is selected, the communication apparatus 100a operates as follows. In this case, the authentication unit 152 executes processing of the authentication phase defined in the DPP by using a public key that is unique to the communication apparatus 100a and different from the common public key. The public key unique to the communication apparatus 100a may be referred to as an individual public key. In addition, when an input specifying that the predetermined wireless setting mode is not to be enabled is received, the bootstrapping unit 151 of the communication apparatus 100a may provide bootstrapping information including the individual public key to the information processing apparatus 200. Furthermore, when an input specifying that the predetermined wireless setting mode is not to be enabled is received, a signal including a value obtained from the individual public key, specifically a hash value of the individual public key, may be broadcast as a DPP Presence Announcement.

The first modification has been described above. When a DPP process is performed using a common public key, one specific public key is used in various wireless settings of the communication apparatus 100a. For this reason, security strength may be reduced. According to the present modification, the user can select whether to use the common public key, thereby enabling appropriate configuration of wireless settings in accordance with the preference of the user. Therefore, according to the present modification, user convenience in configuration of wireless settings is improved.

### Second Modification Example

For example, when the "single device setting mode" described above is selected, the communication apparatus is likely to transmit a DPP Presence Announcement including the hash value of a public key other than the common public key, such as an individual public key. In this case, the information processing apparatus 200 cannot execute processing of the authentication phase by using the common public key. That is, the information processing apparatus 200 needs to acquire bootstrapping information of the communication apparatus 100 or 100a targeted for wireless settings, specifically the public key of the communication apparatus 100 or 100a targeted for wireless settings. Accordingly, when a value obtained from the received DPP Presence Announcement, specifically a hash value, does not match a value obtained from bootstrapping information including the common public key, specifically the hash value, the UI processing unit 255 of the information processing apparatus 200 according to the present modification performs the following operation. That is, in this case, the UI processing unit 255 notifies the user U of acquisition of bootstrapping information of the communication apparatus 100 or 100a that has broadcast the DPP Presence Announcement. That is, also in this case, the UI processing unit 255 notifies the user U of acquisition of bootstrapping information of the communication apparatus 100 or 100a targeted for wireless settings. Specifically, for example, the UI processing unit 255 causes such a notification to be displayed on the UI unit 210. For example, the UI processing unit 255 causes a message such as "Please read the QR code output by the communication apparatus by using the information processing apparatus" to be displayed on the UI unit 210. The UI processing unit 255 may further activate the code reading unit 230, such as a camera. In addition, when bootstrapping information of the communication apparatus 100 or 100a is provided using a PKEX protocol, the UI processing unit 255 may cause a passkey input screen to be displayed on the UI unit 210.

The second modification has been described above. According to the present modification, when a DPP Presence Announcement including a hash value of a public key other than the common public key is transmitted, the user U is notified to acquire an appropriate public key. This enables DPP processing to be performed using an appropriate public key. Accordingly, even when a communication apparatus does not use the common public key, wireless settings of the communication apparatus can be implemented appropriately. The first modification and the second modification can be combined; however, the features of the two modifications do not necessarily have to be combined.

Although the embodiments and the modifications have been described above, processing of the communication apparatuses 100 and 100a, the information processing apparatus 200, and the access point AP may be executed by a computer included in each apparatus. The computer may be configured as a system on a chip (SoC). FIG. 8 is a block diagram illustrating an exemplary hardware configuration of a computer 900 included in the communication apparatus 100 or 100a, the information processing apparatus 200, or the access point AP. As illustrated in FIG. 8, the computer 900 includes, for example, an input-output interface 901, the memory 902, and a processor 903.

The input-output interface 901 is used for communication with any circuit or device.

The memory 902 is composed of, for example, a combination of a volatile memory and a nonvolatile memory. The memory 902 is used to store a program executed by the processor 903, data used for various processing, and other items.

The processor 903 performs various types of processing described in the embodiments described above by reading a program from the memory 902 and executing it. The processor 903 may be, for example, a microprocessor, a microprocessor unit (MPU), or a central processing unit (CPU). In addition, the processor 903 may include a plurality of processors.

The program includes a group of commands, or software code, that, when read by a computer, causes the computer to execute one or more functions described in the embodiments. The program may be stored in a non-transitory computer-readable medium or a solid storage medium. By way of non-limiting example, the computer-readable medium or the solid storage medium includes a random access memory (RAM), a read-only memory (ROM), a flash memory, a solid-state drive (SSD), or another memory technology; a CD-ROM, a Digital Versatile Disk (DVD), a Blu-ray Disc^{®}, or another optical disk storage; and a magnetic cassette, a magnetic tape, a magnetic disk storage, or another magnetic storage device. The program may be transmitted on a transitory computer-readable medium or a communication medium. By way of non-limiting example, the transitory computer-readable medium or the communication medium includes propagating signals in an electrical, optical, acoustic, or another form.

The present disclosure is not limited to the embodiments described above, and may be changed as appropriate within a range without departing from the spirit and scope of the disclosure. For example, a range in which the same common public key is used may be limited to communication apparatuses of the same model or may be limited to communication apparatuses manufactured by the same vendor.

Some or all of the above-described embodiments may also be described below as, but not limited to, the following Supplementary Notes.

### Supplementary Note 1

An information processing apparatus comprising: a bootstrapping unit configured to acquire bootstrapping information defined in Device Provisioning Protocol (DPP), the bootstrapping information including a public key common to a plurality of communication apparatuses; and an authentication unit configured to, when a DPP Presence Announcement broadcast from any one of the plurality of communication apparatuses satisfies a predetermined condition, based on the acquired bootstrapping information, execute processing of an authentication phase defined in the DPP on the communication apparatus having broadcast the DPP Presence Announcement.

### Supplementary Note 2

The information processing apparatus according to Supplementary Note 1, wherein when a value obtained from the DPP Presence Announcement matches a value obtained from the bootstrapping information, the authentication unit is configured to, based on the acquired bootstrapping information, execute processing of the authentication phase on the communication apparatus having broadcast the DPP Presence Announcement.

### Supplementary Note 3

The information processing apparatus according to Supplementary Note 2, further comprising a user interface processing unit configured to, when the value obtained from the DPP Presence Announcement does not match the value obtained from the bootstrapping information, notify a user of acquisition of the bootstrapping information of the communication apparatus having broadcast the DPP Presence Announcement.

### Supplementary Note 4

The information processing apparatus according to any one of Supplementary Notes 1 to 3, wherein the bootstrapping unit is configured to acquire the bootstrapping information from a first communication apparatus among the plurality of communication apparatuses, and the authentication unit is configured to, based on the acquired bootstrapping information, execute processing of the authentication phase on a second communication apparatus having broadcast the DPP Presence Announcement.

### Supplementary Note 5

The information processing apparatus according to Supplementary Note 4, further comprising a user interface processing unit configured to: receive, from a user, an input for specifying whether a communication apparatus targeted for wireless settings is a communication apparatus for which wireless settings are to be configured first among the plurality of communication apparatuses, and when the communication apparatus targeted for wireless settings is the communication apparatus for which wireless settings are to be configured first among the plurality of communication apparatuses, notify the user of acquisition of the bootstrapping information of the first communication apparatus, wherein the authentication unit is configured to: when the communication apparatus targeted for wireless settings is the communication apparatus for which wireless settings are to be configured first among the plurality of communication apparatuses, execute processing of the authentication phase on the first communication apparatus based on the acquired bootstrapping information of the first communication apparatus, and when the communication apparatus targeted for wireless settings is not the communication apparatus for which wireless settings are to be configured first among the plurality of communication apparatuses, search for the DPP Presence Announcement broadcast from any one of the plurality of communication apparatuses.

### Supplementary Note 6

The information processing apparatus according to any one of Supplementary Notes 1 to 3, wherein the bootstrapping unit is configured to acquire the bootstrapping information stored in advance in the information processing apparatus, and the authentication unit is configured to, based on the acquired bootstrapping information, execute processing of the authentication phase on the communication apparatus having broadcast the DPP Presence Announcement.

### Supplementary Note 7

A communication apparatus comprising: a bootstrapping unit configured to broadcast, as a DPP Presence Announcement defined in Device Provisioning Protocol (DPP), a signal including a value obtained from a predetermined public key common to a plurality of communication apparatuses; and an authentication unit configured to execute processing of an authentication phase defined in DPP by using the predetermined public key.

### Supplementary Note 8

The communication apparatus according to Supplementary Note 7, further comprising a user interface processing unit configured to receive, from a user, an input for specifying whether to enable a predetermined wireless setting mode for wireless settings on the plurality of communication apparatuses, wherein when the input specifying that the predetermined wireless setting mode be enabled is received, the bootstrapping unit is configured to broadcast the signal as the DPP Presence Announcement, and the authentication unit is configured to execute processing of the authentication phase by using the predetermined public key.

### Supplementary Note 9

The communication apparatus according to Supplementary Note 8, wherein when the input specifying that the predetermined wireless setting mode is not to be enabled is received, the authentication unit is configured to execute processing of the authentication phase by using a public key that is unique to the communication apparatus and different from the predetermined public key.

### Supplementary Note 10

A processing method comprising: acquiring bootstrapping information defined in Device Provisioning Protocol (DPP), the bootstrapping information including a public key common to a plurality of communication apparatuses; and when a DPP Presence Announcement broadcast from any one of the plurality of communication apparatuses satisfies a predetermined condition, based on the acquired bootstrapping information, executing processing of an authentication phase defined in DPP on the communication apparatus having broadcast the DPP Presence Announcement.

### Supplementary Note 11

A processing method comprising: broadcasting, as a DPP Presence Announcement defined in Device Provisioning Protocol (DPP), a signal including a value obtained from a predetermined public key common to a plurality of communication apparatuses; and executing processing of an authentication phase defined in DPP by using the predetermined public key.

### Supplementary Note 12

A non-transitory computer-readable storage medium storing a program that causes a computer to execute: acquiring bootstrapping information defined in Device Provisioning Protocol (DPP), the bootstrapping information including a public key common to a plurality of communication apparatuses; and when a DPP Presence Announcement broadcast from any one of the plurality of communication apparatuses satisfies a predetermined condition, based on the acquired bootstrapping information, executing processing of an authentication phase defined in DPP on the communication apparatus having broadcast the DPP Presence Announcement.

### Supplementary Note 13

A non-transitory computer-readable storage medium storing a program that causes a computer to execute: broadcasting, as a DPP Presence Announcement defined in Device Provisioning Protocol (DPP), a signal including a value obtained from a predetermined public key common to a plurality of communication apparatuses; and executing processing of an authentication phase defined in DPP by using the predetermined public key.

What is claimed is:

1. An information processing apparatus comprising:
a bootstrapping unit configured to acquire bootstrapping information defined in Device Provisioning Protocol (DPP), the bootstrapping information including a public key common to a plurality of communication apparatuses; and
an authentication unit configured to, when a DPP Presence Announcement broadcast from any one of the plurality of communication apparatuses satisfies a predetermined condition, based on the acquired bootstrapping information, execute processing of an authentication phase defined in the DPP on the communication apparatus having broadcast the DPP Presence Announcement.

2. The information processing apparatus according to claim 1, wherein
when a value obtained from the DPP Presence Announcement matches a value obtained from the bootstrapping information, the authentication unit is configured to, based on the acquired bootstrapping information, execute processing of the authentication phase on the communication apparatus having broadcast the DPP Presence Announcement.

3. The information processing apparatus according to claim 2, further comprising:
a user interface processing unit configured to, when the value obtained from the DPP Presence Announcement does not match the value obtained from the bootstrapping information, notify a user of acquisition of the bootstrapping information of the communication apparatus having broadcast the DPP Presence Announcement.

4. The information processing apparatus according to claim 1, wherein
the bootstrapping unit is configured to acquire the bootstrapping information from a first communication apparatus among the plurality of communication apparatuses, and
the authentication unit is configured to, based on the acquired bootstrapping information, execute processing of the authentication phase on a second communication apparatus having broadcast the DPP Presence Announcement.

5. The information processing apparatus according to claim 4, further comprising a user interface processing unit configured to:
receive, from a user, an input for specifying whether a communication apparatus targeted for wireless settings is a communication apparatus for which wireless settings are to be configured first among the plurality of communication apparatuses, and
when the communication apparatus targeted for wireless settings is the communication apparatus for which wireless settings are to be configured first among the plurality of communication apparatuses, notify the user of acquisition of the bootstrapping information of the first communication apparatus, wherein
the authentication unit is configured to:
when the communication apparatus targeted for wireless settings is the communication apparatus for which wireless settings are to be configured first among the plurality of communication apparatuses, execute processing of the authentication phase on the first communication apparatus based on the acquired bootstrapping information of the first communication apparatus, and
when the communication apparatus targeted for wireless settings is not the communication apparatus for which wireless settings are to be configured first among the plurality of communication apparatuses, search for the DPP Presence Announcement broadcast from any one of the plurality of communication apparatuses.

6. The information processing apparatus according to claim 1, wherein
the bootstrapping unit is configured to acquire the bootstrapping information stored in advance in the information processing apparatus, and
the authentication unit is configured to, based on the acquired bootstrapping information, execute processing of the authentication phase on the communication apparatus having broadcast the DPP Presence Announcement.

7. A communication apparatus comprising:
a bootstrapping unit configured to broadcast, as a DPP Presence Announcement defined in Device Provisioning Protocol (DPP), a signal including a value obtained from a predetermined public key common to a plurality of communication apparatuses; and
an authentication unit configured to execute processing of an authentication phase defined in DPP by using the predetermined public key.

8. The communication apparatus according to claim 7, further comprising:
a user interface processing unit configured to receive, from a user, an input for specifying whether to enable a predetermined wireless setting mode for wireless settings on the plurality of communication apparatuses, wherein
when the input specifying that the predetermined wireless setting mode be enabled is received,
the bootstrapping unit is configured to broadcast the signal as the DPP Presence Announcement, and
the authentication unit is configured to execute processing of the authentication phase by using the predetermined public key.

9. The communication apparatus according to claim 8, wherein
when the input specifying that the predetermined wireless setting mode is not to be enabled is received, the authentication unit is configured to execute processing of the authentication phase by using a public key that is unique to the communication apparatus and different from the predetermined public key.

10. A processing method comprising:
acquiring bootstrapping information defined in Device Provisioning Protocol (DPP), the bootstrapping information including a public key common to a plurality of communication apparatuses; and
when a DPP Presence Announcement broadcast from any one of the plurality of communication apparatuses satisfies a predetermined condition, based on the acquired bootstrapping information, executing processing of an authentication phase defined in DPP on the communication apparatus having broadcast the DPP Presence Announcement.
